(19) United States
(12) Patent Application Publication
(10) Pub. No.: US 2025/0003218 A1
(43) Pub. Date: Jan. 2, 2025

(54) Flashing member and a method for making a flashing member

(71) Applicant: VKR Holding A/S, Hørsholm (DK)

(72) Inventor: KRISTIAN STRAND GRØNBÆK, Gedved (DK)

(21) Appl. No.: 18/755,564

(22) Filed: Jun. 26, 2024

(30) Foreign Application Priority Data
Jun. 28, 2023 (DK) PA 2023 70344

(51) Int. Cl. E04D 13/03; E06B 1/62; E06B 7/26

(52) U.S. Cl. CPC E04D 13/031; E06B 1/62; E06B 7/26; E06B 2001/628

(57) ABSTRACT

A flashing member (30, 32, 33) for a roof window (1) and a method for making a flashing member is disclosed. The flashing member is made from a sheet material and comprises an elongate main element (301) and at least one end element (302), attached to the main element (301) at one end by a folded seam connection (303). The main element (301) comprises a first section (3011) extending along a length axis (L) and a height axis (H) of the flashing member, a second section (3012) extending along the length axis and a width axis (W), and a planar third section (3013) extending between the first section (3011) and the second section (3012). The method comprises bending a first piece of sheet material twice along two parallel lines to form the third section of the main element and possibly compressing the folded seam connection into a flat lock seam.

### TECHNICAL FIELD

The present invention relates to a flashing member for a roof window comprising a frame, said frame comprising a top frame member, a bottom frame member, and two side frame members, said frame members delimiting a frame opening and each frame member having an outer side facing away from the frame opening, where said flashing member is made from a sheet material, where said flashing member comprises an elongate main element having two ends and at least one end element, where the main element comprises a first section extending along a length axis and a height axis of the flashing member, and a second section extending along the length axis and a width axis of the flashing member, said length axis extending between the two ends of the main element, and where the at least one end element is attached to the main element at one end and connected to the first section and the second section by a folded seam connection. The invention further relates to a method for making a flashing member.

### BACKGROUND ART

A flashing member forms part of a flashing assembly used for weatherproofing the joint between a roof window and an inclined roof structure in which the roof window is installed. The flashing member is configured for being arranged with the length axis extending in parallel to a length axis of a frame member of the roof window, the first section is configured for extending along the outer side of the frame member, and the second section is configured for extending away from the outer side of the frame member and the frame opening. In the mounted state the first section thus engages directly or indirectly with the outer side of the frame member, and the second section extends substantially in plane with the roof structure. An indirect engagement may for example occur where an insulating frame is arranged around the frame of the roof window. If the flashing member is used as a bottom flashing member and the roof window is mounted deep in the roof structure, the second section may have a slight upwards inclination, e.g. by extending at an angle of less than 90 degrees in relation to the first section, so that it may lift water up to the level of the exterior side of a roof material used underneath the roof window seen in the direction of inclination of the roof structure. The first and second sections are typically made from a single sheet of metal and separated by a bend, so that an exterior side of the main element facing an exterior in a mounted state is concave. The bend may be sharp or having a larger radius so that the main element has a curved appearance. Such flashing members have been used for many years and provide excellent watertightness and durability, but as they are typically made from metal or metal alloys with a high percentage of virgin metal, such as aluminium or cupper, they have a relatively high carbon footprint.

### SUMMARY OF INVENTION

With this background, it is an object of the invention to provide a flashing member, which can be made from materials having a lower carbon footprint than those presently used while maintaining watertightness and durability.

In a first aspect of the invention, this and further objects are achieved with a flashing member of the kind mentioned in the introduction, which is furthermore characterised in that the main element further comprises a plane third section extending between the first section and the second section, said third section extending along the length axis and at an angle to both the first section and the second section.

With the introduction of the planar third section there will be two bends when the main element is made of one piece of sheet material, a first bend between the first section and the third section and a second bend between the second section and the third section, said first bend and said second bend both extending in parallel to the length axis of the flashing member.

A bend between the first and second section necessitates a corresponding bend on the folded seam of the folded seam connection and causes a stretching of the material on one side, where there is an angle of more than 180 degrees between the first and second section, and a compression of the material on the other side, where there is an angle of less than 180 degrees between the first and second section. In the prior art flashing members having a sharp bend, i.e., a bend with a small radius, typically 1-5 millimeters, these deformations are all concentrated at the bend. Soft metals, such as lead and virgin aluminium alloys, are able to deform sufficiently to compensate for these deformations, but when using recycled aluminium and other less ductile materials, the stretching may lead to cracks or holes in the sheet material, which typically has a thickness of 0.3-1.0 mm, most often 0.5-0.7 mm. Cracks typically appear in the material of the folded seam, and holes typically appear in the sheet material adjacent to the folded seam as the stretching makes it too thin to remain unbroken. With the provision of the third section, the deformation is distributed on two bends, at a distance from each other. This not only means that the deformation required at each bend is reduced, but also that material can be drawn from a larger area of the respective sheet materials, thus reducing the risk of rupturing the sheet materials.

As compared to prior art flashing members where the radius is larger, forming a continuous curve, the provision of the third section and the two bends provides a locking of the end element in relation to the main element. This prevents the end element and the main element from sliding in relation to each other in directions perpendicular to the length axis and provides a better control of the drawing of material during the formation of the folded seam connection, as material will primarily be drawn from the areas adjacent to a bend on either side thereof.

The advantages provided by the two bends are particularly pronounced in flashing members for use with roof windows mounted deep in the roof and/or having a low frame so that the height of the main element along the height axis needs to be small, as there is then only a small amount of material for drawing. In some embodiments, the total height of the main element along the height axis is 25-60 mm, preferably less than 50 mm, still more preferred less than 40 mm.

In one embodiment, the third section extends at angles of 120-140 degrees with respect to the first section and the second section measured at the exterior side of the flashing member, i.e., the side facing the exterior in the mounted state. If the height axis and the width axis defined by the first section and second section, respectively, are substantially perpendicular, it is presently considered advantageous that the two bends are of approximately the same size, contributing to an even distribution of tension. It may, however, also be advantageous to make the two bends with different angles, for example to achieve a shape of the main element, which provides good water drainage properties and/or prevents accumulation of dirt, hail, or snow.

As mentioned above, if the flashing member is a bottom flashing member for use at the bottom frame member of a roof window mounted in an inclined roof structure, the second section may be configured for extending at an angle to a plane defined by the roof structure so that it may lead water onto the roofing material below the roof window. The width axis may then not be perpendicular to the height axis, and the angle between the first section and the second section will then be less than 90 degrees measured at the exterior side. In that case the angles between the third section and the first and the second sections will be correspondingly smaller.

It is presently considered advantageous that the third section extends at angles of at least 110 degrees measured at the exterior side, preferably at least 120 degrees, with respect to both the first section and the second section.

The folded seam connection used for attachment of the at least one end element to the main element may be a flat lock seam, where each of the end element and the main element comprises a bent edge, where said bent edges hook into each other, and where the seam has been compressed so that the bent edges are pressed firmly against each other. The bent edges hooked into each other provides a surplus of material, which may be drawn from when forming the bends between the third section and the first and second sections. Furthermore, the hooked engagement of bent edges allows the material of the end element and the main element to move somewhat in relation to each other during an initial phase of the deformation process for forming the bends, thus facilitating material redistribution, but eventually fixating the two elements to each other.

In one embodiment, the flashing member further comprises a fourth section extending from an edge of the first section opposite the third section, where said fourth section is configured for engaging with an exterior side of a frame member in the mounted state. The exterior side of the frame member faces the exterior when the roof window is mounted in a roof of a building, and the fourth section thus allows the flashing member to rest on the frame member, defining the position of the flashing member relative to the roof structure in the direction of the height axis and perpendicular to the plane of the roof structure.

The flashing member may further comprise a fifth section extending from an edge of the fourth section opposite the first section, such that the first section, the fourth section, and the fifth section form a right-angled U-shape. This will allow the flashing member to hook over an exterior section of the frame member, thereby hindering movement of the flashing member in a direction parallel to the plane of the roof structure once mounted.

In one embodiment, the flashing member further comprises a reinforcement element mounted or configured for being mounted on an interior side of the flashing member at the first section, i.e., facing the frame of the roof window. The reinforcement element may have a right-angled U-shape corresponding to that formed by the first, fourth, and fifth sections described above, and it may be configured for being accommodated inside the U-shape formed by the first, fourth, and fifth sections on the interior side of the flashing member. When having a U-shape, the reinforcement element may hook onto an exterior section of the frame member as described above with reference to the flashing member itself. The reinforcement element is preferably made from an elastic material, such as steel, aluminium, or a polymer. The reinforcement element is preferably shorter than the main element of the flashing member along the length axis. Two or more reinforcement elements may be arranged at a distance from each other along the length axis. The reinforcement elements may be attached to the main element of the flashing member or be provided separately and come into engagement with it during mounting of the flashing member.

In one embodiment, the flashing member further comprises a sixth section extending from an edge of the second section opposite the third section. If the flashing member is intended for use as a top flashing member or a side flashing member, the sixth section may be configured for extending underneath a roofing material. If the flashing member is intended for use as a bottom flashing member, a skirt element may be attached to the sixth section, or the sixth section may itself be configured for serving as a skirt element extending over a roofing material.

A skirt element may also be attached to the main element of a bottom flashing member in other ways, so that it extends in continuation of the second section. This may be achieved for example by welding or by means of an adhesive.

The sheet material may be sheet metal, preferably an aluminium alloy, which preferably comprises at least 50%, preferably at least 90% recycled aluminium. Aluminium alloys have proven well suited for use in flashing assemblies, as they are elastic, highly weather-resistant, and easily recyclable. Soft temper aluminium of the 3000 series is presently considered well suited. Other metals, such as steel or cupper and alloys thereof, polymers, and composites, such as polymers reinforced by fibres or mesh, may also be used.

The main element and the end element may be made from different materials. Typically, the end element will be made from a material, which bends more easily than the main element. When using aluminium alloys, it is presently considered advantageous that the main element is made from an alloy having an elongation at break of at least 6% and that the end element is made from an alloy having an elongation at break of at least 12%. The elongation at break is measured in accordance with EN ISO 6892-1:2019. Preferably, the elongation at break of the aluminium alloy used for the main element is 6-24% and the elongation at break of the aluminium alloy used for the main element is 12-32%. In one embodiment, the elongation at break of the aluminium alloy used for the main element is at least 15% and the elongation at break of the aluminium alloy used for the main element is at least 30%.

The flashing member may for example be a bottom flashing member configured for being mounted at the bottom frame member of a roof window mounted in an inclined roof, i.e., below the roof window when seen in the direction of inclination of the roof structure. Bottom flashing members are subject to high water loads and high wind loads, and their watertightness is therefore of critical importance. Furthermore, a bottom flashing member will receive water draining off the pane of the roof window and therefore typically has to project into the roof structure. This requires more material and often a higher degree of deformation of the material during manufacture than when making for example side flashing members. A reduction of the risk of cracking and over-stretching is therefore particularly advantageous in relation to bottom flashing members.

In a second aspect of the invention, the above mentioned and further objects are achieved with a method for making a flashing member for a roof window comprising a frame, said frame comprising a top frame member, a bottom frame member, and two side frame members, said frame members delimiting a frame opening, and each frame member having an outer side facing away from the frame opening, said method comprising the steps of:
A) Providing a first piece of sheet material and a second piece of sheet material,
B) Forming an elongate main element having two ends from the first piece of sheet material, such that the main element comprises a first section extending along a length axis and a height axis of the flashing member, and a second section extending along the length axis and a width axis of the flashing member, said length axis extending between the two ends of the main element,
C) Forming an end element from the second piece of sheet material,
D) Attaching the at least one end element is to the main element at one end of the main element by a folded seam connection, thereby connecting the end element to the first section and the second section,
wherein step B) comprises forming a planar third section extending between the first section and the second section by bending the first piece of sheet material twice along two parallel lines, so that said third section extends along the length axis and at an angle to both the first section and the second section.

As described above with reference to the first aspect of the invention, the provision of two bends, one on either side of the third section, means that the tension arising from the deformation at the folded seam connection can be controlled and maintained within levels allowing the flashing member to be made from recycled aluminium alloys and other less ductile materials.

When step D) is performed after step B), the folded seam connection will also get two bends and the material of the folded seam connection located at the bends will be deformed, whereas material located at the centre of the first, second, and third sections will primarily be pressed against the material of the other piece of sheet material. On the concave exterior side of the flashing member, the material will be compressed, whereas the material on the convex interior side of the flashing member will be stretched. Experiments have shown that with the two separate bends, the compression can be absorbed by neighbouring part of the folded seam connection and the stretching can be compensated for by drawing on the material of neighbouring part of the folded seam connection.

In one embodiment, step D) comprises the steps of: D1) Folding an edge flange of the second piece of sheet material into a hook shape and engaging said edge flange of the second piece of sheet material with an edge flange of the first piece of sheet material, and D2) Folding said edge flanges onto the first piece of sheet material thereby forming the folded seam connection. Folding said edge flanges onto the first piece of sheet material, i.e., onto the main element, means that the deformation of material at the bends can happen at the same time as the formation of the folded seam connection. This in turn means that at least some of the deformation happens at a time, where there is still only a loose contact between the first piece of sheet material and the second piece of sheet material. This may facilitate the drawing of material from neighbouring parts and/or that material is pushed away from the bends.

The end element will usually comprise a section extending in direction perpendicular to the length axis and being configured for extending along a side frame member of the roof window in the mounted state and the folded seam connection will usually be located close to this section. In such cases the folding of the edge flanges onto the main element will involve the formation of two bends close to each other on the second piece of sheet material whereas only one bend will be needed on the main element. To allow this additional deformation of the end element, the second piece of sheet material may be made from a material having a higher ductility than the first piece of sheet material. This particularly applies if the flashing member is a bottom flashing member, where the main element should be able to carry the load of water, snow, and ice accumulating underneath the roof window, and be resistant to wind loads.

In some embodiments, the step D) comprises the step of D3) compressing the folded seam connection into a flat lock seam by pressing in a direction perpendicular to the length axis. The compression brings the two pieces of sheet material into a tight engagement, thereby contributing to the strength and stability of the flashing member. The compression could alternatively be achieved as part of a process of folding edge flanges of the two pieces of sheet material onto the first piece of sheet material, corresponding to step D2) above, i.e., applying pressure primarily in parallel to the length axis. Applying pressure in parallel to the length axis, however, involves a risk of pulling the edge flanges out of engagement with each other, as the part of the second sheet material adjacent to the edge flange, which will be in contact with the pressing tool, may be drawn longer, while the edge flange is pulled along, affected only by the frictional contact with the first piece of sheet material and largely maintaining it's original shape. By the application of pressure in a direction perpendicular to the length axis, on the other hand, pressure is applied substantially equally to the edge flanges and the adjacent parts of the pieces of sheet material. Pressing in a direction perpendicular to the length axis after the completion of the folding thus increases the likelihood of achieving a watertight and durable connection.

To provide additional functionality to the flashing member, the method may further comprises one or more of the step of:
E) Forming a fourth section extending from an edge of the first section opposite the third section by bending the first piece of sheet material,
F) Forming a fifth section extending from an edge of the fourth section opposite the first section by bending the first piece of sheet material, such that the first section, the fourth section and the fifth section form a right-angled U-shape,
G) Attaching a reinforcement element at an interior side of the first section,
H) Forming a sixth section extending from an edge of the second section opposite the third section by bending the first piece of sheet material,
I) Attaching a skirt element to the sixth section.

Embodiments and advantages described with reference to the first aspect of the invention also applies to the second aspect of the invention and vice versa but may have been described only with reference to one or them to avoid undue repetition. This means that the devices described with reference to the first aspect can all be made by the method described with reference to the second aspect, and that the method described with reference to the second aspect can comprises the formation of the device features described with reference to the first aspect.

### BRIEF DESCRIPTION OF DRAWINGS

In the following description embodiments of the invention will be described with reference to the schematic drawings, in which

FIG. 1 is a perspective view of a roof window mounted in an inclined roof structure with a flashing assembly;

FIG. 2 is enlargement of the section marked II in FIG. 1;

FIG. 3 corresponds to FIG. 1, but showing only the flashing assembly and with sealing elements removed;

FIG. 4 corresponds to FIG. 2, but showing only the flashing assembly and with sealing elements removed;

FIG. 5 is a perspective partial view of a bottom flashing member, at the position marked V in FIG. 4;

FIG. 6 shows a cross-section along the line VI-VI in FIG. 5;

FIG. 7 is a top view as indicated by the arrow VII in FIG. 5;

FIG. 8 shows a cross-section along the line VIII-VIII in FIG. 4;

FIG. 9 is a perspective view of a reinforcement element; and

FIG. 10 corresponds to FIG. 8, only seen from a slightly different angle and further showing a bottom frame member of a roof window and an insulating frame.

### DESCRIPTION OF EMBODIMENTS

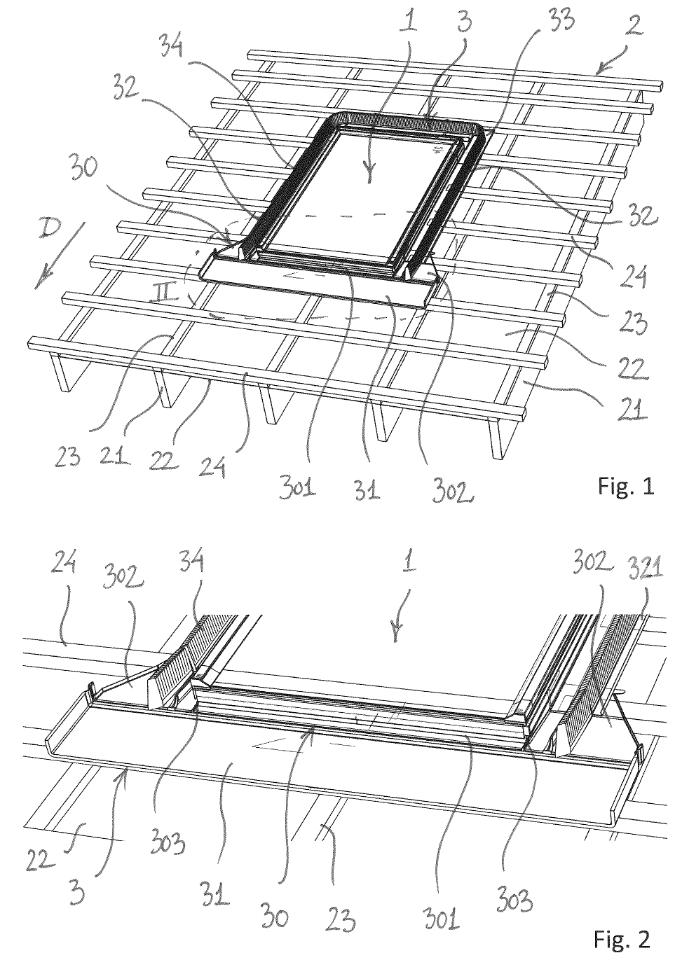

Referring initially to FIG. 1 and FIG. 2, a roof window 1 is shown mounted in in inclined roof structure 2, also referred to as a pitched roof structure, with a flashing assembly 3 covering the joint between the roof window and the roof structure. The roof structure is pitched with a downward direction of inclination D and comprises rafters 21, an underroof 22, counter-battens 23, and laths 24. The roof structure and the flashing assembly are here configured for use with an undulated roofing material (not shown), such as tiles. The roofing material will be supported by the laths, and the bottom flashing member 30 of the flashing assembly is connected to a skirt element 31 configured for extending over the roof material underneath the roof window. On the side flashing members 32 and the top flashing member 33, sealing elements 34 are provided for closing a gap between the flashing assembly 3 and the roofing material.

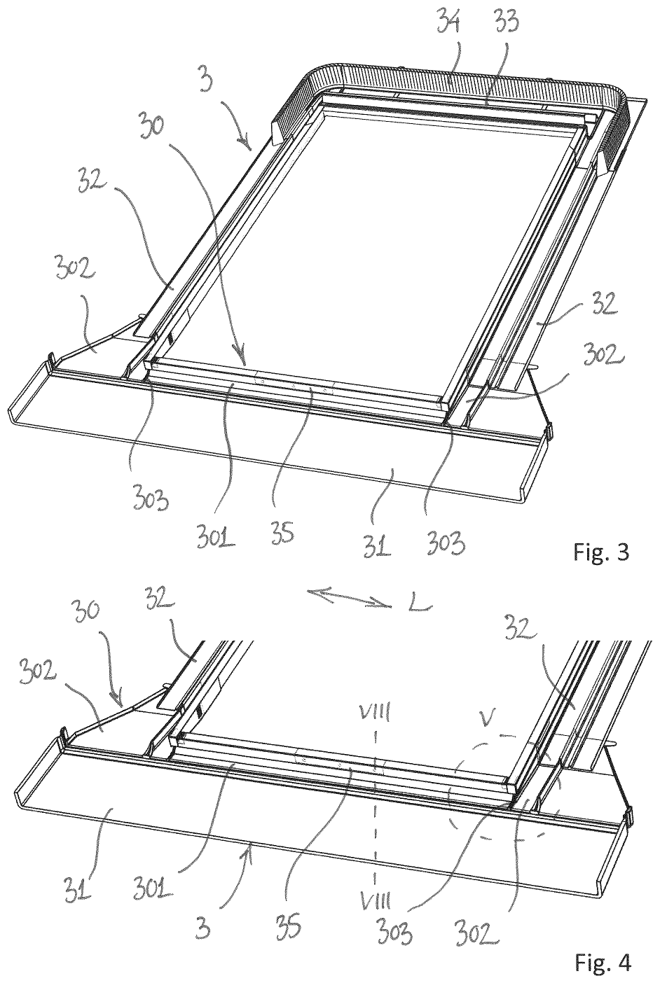

As better seen in FIG. 2, and in FIG. 3 and FIG. 4 where the sealing elements 34 on side flashing members 32 have been removed, the bottom flashing member 30 comprises an elongate main element 301 and two end elements 302, one at each end of the main element as seen along a length axis L. The end elements overlap with the side flashing members 32 and the skirt element 31 extends over the total length of the main element and two corner elements, so that water draining off the side flashing members will be lead over the end elements onto the skirt element, from where it may drain off onto the roof structure underneath the roof window.

In FIG. 3 and FIG. 4 the main element 301 of the bottom flashing member 30 has been shown as transparent, so that a reinforcement element 35 located on the interior side of the main element is visible. The reinforcement element will be described in more detail below.

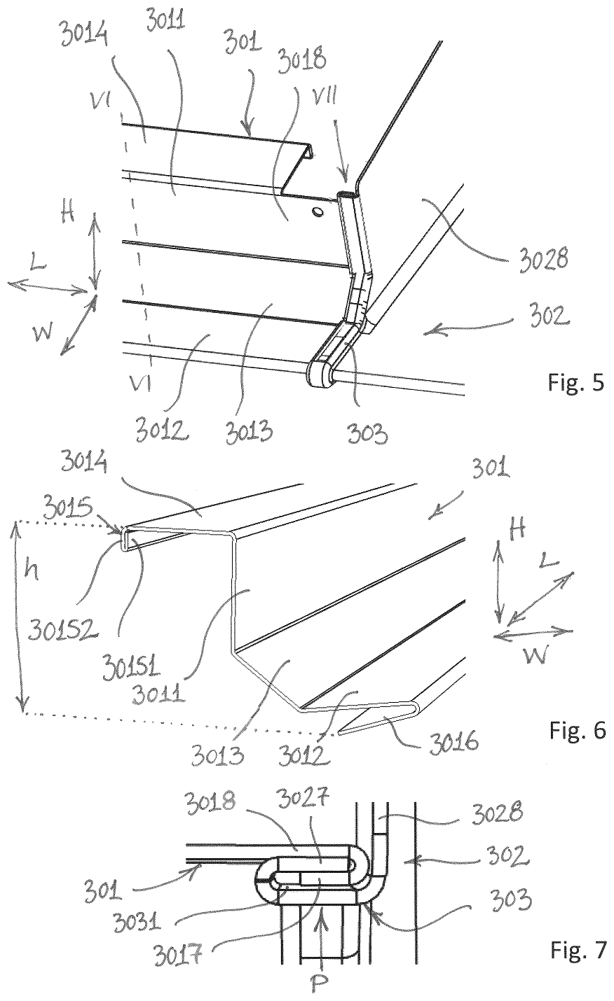

The shape of the main element 301 of the bottom flashing member 30 is seen in FIG. 5 and FIG. 6, which show a section of the righthand end of the bottom flashing member 30, corresponding to the position marked V in FIG. 4, and a cross-section along the line VI-VI in FIG. 5. In these figures, the roof window, the roof structure, and all other parts of the flashing assembly have been removed, so that only the main element 301 and the righthand end element 302 are seen.

The main element 301 comprises a first section 3011 extending along the length axis L and a height axis H, a second section 3012 extending along the length axis and a width axis W, and a planar third section 3013 extending between the first section and the second section, along the length axis and at an angle to both the first section and the second section. The third section thus also extends at an angle to the height axis H and to the width axis W.

In the embodiment in FIG. 6, the height axis H and the width axis W extend at an angle of 83 degrees to each other, the angle between the first section 3011 and the third section 3013 is 135 degrees, and the angle between the third section 3013 and the second section 3012 is 128 degrees.

The total height h of the main element along the height axis H is in this embodiment approximately 40 mm and the height of the first section 3011 and the width of the second section 3012 along the width axis W are each approximately 20 mm. It is to be understood that these dimensions may vary depending on the intended use of the flashing member and that the relative dimensions, such as the width of the second section relative to the height of the first section, may also be different than shown, for example to facilitate the attachment of a skirt as will be described below. The same applies to the angles mentioned above, and the need for changing a dimension may result in a change in one or both angles between sections or vice versa.

In addition to the first, second, and third sections, the main element 301 here further comprises a fourth section 3014 extending from an edge of the first section 3011 opposite the third section, a fifth section 3015 extending from an edge of the fourth section opposite the first section, and a sixth section 3016 extending from an edge of the second section opposite the third section. All are made from one piece of sheet metal and are separated from each other by bends. The function of the fourth, fifth, and sixth section will be described in further detail below.

The joint between the main element 301 and the righthand end element 302 is embodied as a folded seam connection 303, which is shown from above in FIG. 7. On the main element 301 an edge has been bent such that an edge flange 3017 extends back along the main body 3018 of the element forming a hook shape. On the end element 302 an edge has been bent twice, such that an edge flange 3027 extends back towards the main body 3028, at a 90 degrees angle to the main body, and forming a hook shape engaging with the hook shape on the main element 301. The folded seam connection shown in FIG. 5 and FIG. 7 has been formed by the following sequence of steps:

Bending the edge flange 3017 of the main element 301 so that it extends at 90 degrees relative to the main body 3018;

Bending the edge flange 3027 of the end element 302 so that it extends at 180 degrees relative to the main body 3028, forming a hook shape;

Hooking the end element 302 onto the edge flange 3017 of the main element 301, such that the edge flanges 3017, 3027 extend in parallel and adjacent to each other; and

Folding both edge flanges 3017, 3027 onto the main body 3018 of the main element thereby forming the folded seam connection as shown in FIG. 7.

The folded seam connection 303 shown in FIG. 5 and FIG. 7 may be transformed into a flat lock seam by pressing in a direction perpendicular to the length axis as indicated by the arrow P. When doing so, the sheet material of the main element 301 and the sheet material of the end element 302 will be compressed and brought into tight contact with each other, eliminating the space 3031 seen in FIG. 7. This compression with result in a stronger connection, as friction between the main element 301 and the end element 302 will prevent them from moving in relation to each other, and the absence of a space between them will contribute to an increased watertightness.

It is to be understood that the lefthand end element can be connected to the main element in the same way as described above, but that it is does not need to be the case and/or that the end elements may be embodied differently. It is also possible to have a flashing member with an end element only at one end, for example if it is to be used in a group of roof windows mounted closely adjacent to each other.

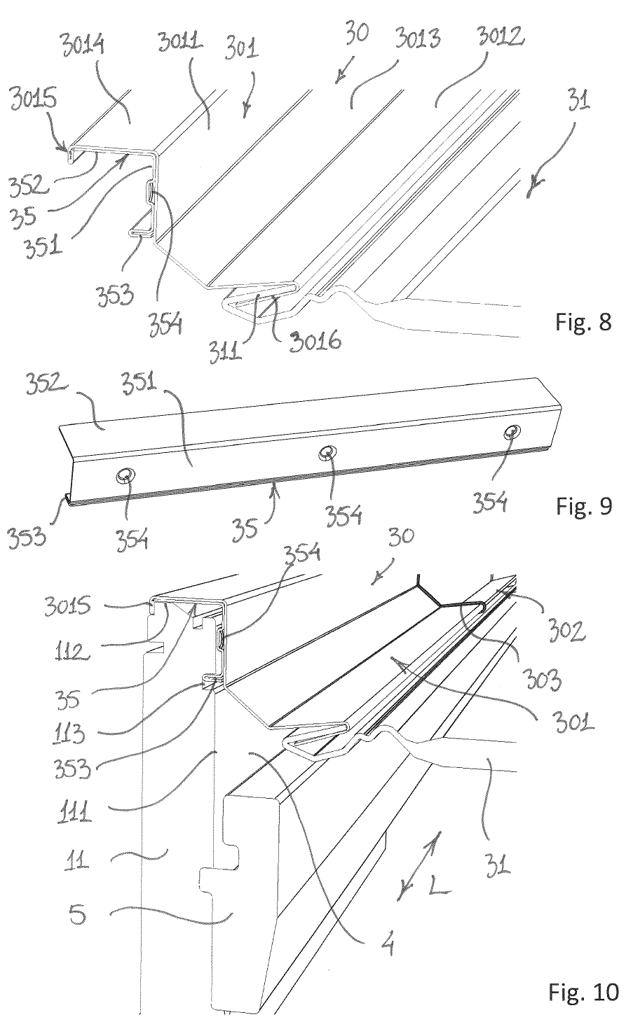

In FIG. 8 the main element 301 in FIG. 6 is shown with a reinforcement element 35 at the interior of the first section 3011 and a skirt element 31 attached at the second section 3012, extending in continuation thereof.

The reinforcement element 35, which is shown in FIG. 9, has the overall shape of an L with a first leg 351 extending along the first section 3011 in the mounted state and a second leg 352 extending along the fourth section 3014. In the mounted state shown in FIG. 10, the first leg extends along an outer side 111 of a frame member 11 of the frame of the roof window, here a bottom frame member, and holes 354 are provided so that the reinforcement element can be attached to the frame member using screws or like fasteners. The second leg 352 rest on the exterior side 112 of the frame member 11, i.e., the side facing the exterior in the mounted state of the roof window, and thus determines how deep in the roof structure the flashing member 30 reaches. In this embodiment the reinforcement element 35 further comprises a shorter third leg 353, which engages with a groove 113 in the outer side 111 of the frame member. The third leg may help in positioning the flashing member 30 correctly during mounting and may help to prevent that the flashing member is lifted off the frame member once mounted, for example under the influence of wind suction. The length of the second leg 352 corresponds to the distance between the first section 3011 and the fifth section 3015 of the main element 301, which form a right-angled U-shape together with the fourth section 3014, so that the bottom flashing member can hook onto the reinforcement element 35 as shown in FIG. 8 and FIG. 10. The unit consisting of the main element 301 and the reinforcement element 35 is stronger and stiffer than the main element 301 alone, giving the bottom flashing member a better resistance to wind loads, particularly to wind suction.

As is best seen in FIG. 6, the fifth section 3015 is here formed from two layers of the sheet material bent onto each other, where the interior layer 30151 is shorter than the exterior layer 30152, so that a recess is formed between the interior layer and the fourth section 3014. This allows the bottom flashing member 30 to snap onto the reinforcement element 35, the edge of the second 352 leg of the reinforcement element opposite the first leg 351 engaging with the recess. The fifth section may, however, also be a simple one-layer edge flange.

Likewise, the shorter third leg 353 of the reinforcement element 35 is here shown as made from two layers of sheet material to provide strength and stiffness, but could also be a one-layer edge flange.

The reinforcement element 35 shown is considerably shorter along the length axis L than the main element 301. A longer reinforcement element would provide more strength in the mounted state, but could also make mounting more difficult.

It would also be possible to mount the bottom flashing member 30 without the reinforcement element 35. In that case the fourth section 3014 of the main element 301 would rest directly on the exterior side 112 of the frame member 11, or the first section 3011 could be attached to the outer side 111 of the frame member 11 using screws or like fasteners as described with reference to the reinforcement member above. In the latter case, the main element could be without the fourth section.

The sixth section 3016 of the main element 301 is used for the attachment of the skirt element 31 as shown in FIG. 8 and FIG. 10. The sixth section 3016 forms a hook shape together with the second section 3012, and the skirt element also has a bent edge 311 forming a hook shape. These two hook shapes engage with each other and may be pressed more tightly together than shown to establish a firm connection. Alternatively, or additionally, an adhesive or sealing (not shown) may be provided between them.

As seen in FIG. 10 a space 4 is present between the bottom flashing member 30 and an insulating frame 5 arranged at the outer side 111 of the bottom frame member 11. This space may give room for component of the roof structure or for additional insulating material.

The slight upward inclination of the sixth section 3016 also explained with reference to FIG. 6 may facilitate connection to the skirt member 31, but in the embodiment shown it corresponds to the inclination of the parts of the end elements 302 extending from the ends of the side flashing members 32 to the skirt member 31, as is best seen in FIG. 4. As is well known to the skilled person, this inclination will depend on how deep the roof window is mounted in the roof structure and the kind of roofing material to be used. Had the flashing assembly 3 been intended for use with a flat roofing material, such as slate, the inclination would not have been necessary, and the first section 301 and the second section 302 of the main element could have been perpendicular to each other.

The flashing assembly 3 shown in the drawing is configured for being made entirely from aluminium alloy 3003, temper H41 whereas at least some elements of the applicant prior art flashing assemblies have been made from the more ductile aluminium alloy 8011, containing less manganese and more iron and silicon.

The reinforcement element 35 may be made from the same aluminium alloy, and so may the outer parts of the skirt element 31.

Above the flashing member has primarily been described with reference to a bottom flashing member 30, but could also be a top flashing member 33 or possibly a side flashing member 32, even though end elements are most commonly used on top and bottom flashing members. The relative dimensions of the first, second, and third sections might then be different, and the fourth, fifth and sixth sections might be embodied differently or not be present. In case of a top flashing member 33 the second section would be considerably longer than the second section 302 shown in the drawing, so that it could extend up underneath a roof material above the roof window 1, or a flat sixth section extending in continuation of the second section could be provided. In case of a side flashing member 32, the sixth section would replace the outer section 321 on which the sealing element 34 is located in FIG. 2.

### LIST OF REFERENCE NUMERALS

1 Roof window
11 Bottom frame member
111 Outer side
112 Exterior side
113 Groove
2 Roof structure
21 Rafter
22 Underroof
23 Counter-battens
24 Lath
3 Flashing assembly
30 Bottom flashing member
301 Main element
3011 First section
3012 Second section
3013 Third section
3014 Fourth section
3015 Fifth section
30151 Interior layer
30152 Exterior layer
3016 Sixth section
3017 Edge flange
3018 Main body
302 End element
3027 Edge flange
3028 Main body
303 Folded seam connection
3031 Space
31 Skirt element
311 Bent edge
32 Side flashing member
321 Outer section
33 Top flashing member
34 Sealing element
35 Reinforcement element
351 First leg
352 Second leg
353 Third leg
354 Hole
4 Space
5 Insulating frame
L Length axis
H Height axis
W Width axis
D Direction of inclination
P Pressure

1. A flashing member for a roof window comprising a frame, said frame comprising a plurality of frame members including a top frame member, a bottom frame member, and two side frame members, said plurality of frame members delimiting a frame opening and each of said plurality of frame members having an outer side facing away from the frame opening,
where said flashing member is formed from a sheet material,
where said flashing member comprises an elongate main element having two ends and at least one end element,
where the elongate main element comprises a first section extending along a length axis and a height axis of the flashing member, and a second section extending along the length axis and a width axis of the flashing member, said length axis extending between the two ends of the elongate main element, and
where the at least one end element is attached to the elongate main element at one end and connected to the first section and the second section by a folded seam connection,
the elongate main element further comprises a planar third section extending between the first section and the second section, said planar third section extending along the length axis and at an angle to both the first section and the second section.

2. The flashing member according to claim 1, where planar the third section extends at angles of 120-140 degrees with respect to the first section and the second section.

3. The flashing member according to claim 1, where the planar third section extends at angles of at least 110 degrees with respect to the first section and the second section.

4. The flashing member according to claim 1, where height axis and the width axis are substantially perpendicular to each other, and the first section and the second section extend in directions that are substantially perpendicular to each other.

5. The flashing member according to claim 1, where the folded seam connection is a flat lock seam.

6. The flashing member according to claim 1, further comprising at least one of:
a fourth section extending from an edge of the first section opposite the planar third section, said fourth section being configured for engaging with an exterior side of a frame member in the mounted state,
a fifth section extending from an edge of the fourth section opposite the first section, such that the first section, the fourth section and the fifth section form a right-angled U-shape,
a reinforcement element configured for being mounted at an interior side of the first section,
a sixth section extending from an edge of the second section opposite the planar third section, and
a skirt element attached to the sixth section or the second section.

7. The flashing member according to claim 1, where the flashing member is configured for use as a bottom flashing member mounted at the bottom frame member of the roof window mounted in an inclined roof.

8. The flashing member according to claim 7, where a skirt element extends in continuation of the second section.

9. The flashing member according to claim 1, where the sheet material is sheet metal.

10. The flashing member according to claim 1, where a total height of the elongate main element along the height axis is 25-60 mm.

11. A roof window mounted in an inclined roof structure, where a flashing member according to claim 1 is mounted at a bottom frame member of the roof window, below the roof window when seen in a direction of inclination of the inclined roof structure.

12. A method for making a flashing member for a roof window comprising a frame, said frame comprising a plurality of frame members including a top frame member, a bottom frame member, and two side frame members, and said plurality of frame members delimiting a frame opening, each of said plurality of frame members having an outer side facing away from the frame opening, said method comprising the steps of:
A) providing a first piece of sheet material and a second piece of sheet material,
B) forming an elongate main element having two ends from the first piece of sheet material, such that the elongate main element comprises a first section extending along a length axis and a height axis of the flashing member, and a second section extending along the length axis and a width axis of the flashing member, said length axis extending between the two ends of the elongate main element,
C) forming an end element from the second piece of sheet material,
D) attaching the at least one end element to the elongate main element at one end of the main element by a folded seam connection, thereby connecting the end element to the first section and the second section,
where step B) comprises forming a planar third section extending between the first section and the second section by bending the first piece of sheet material twice along two parallel lines, so that said planar third section extends along the length axis and at an angle to both the first section and the second section.

13. The method according to claim 12, where step D) comprises the steps of:
D1) folding an edge flange of the second piece of sheet material into a hook shape and engaging said edge flange of the second piece of sheet material with an edge flange of the first piece of sheet material, and
D2) folding said edge flanges onto the first piece of sheet material thereby forming the folded seam connection.

14. The method according to claim 13, where step D) comprises the step of:
D3) compressing the folded seam connection into a flat lock seam by pressing in a direction perpendicular to the length axis (L).

15. The method according to claim 12, further comprising one or more of the steps of:
E) forming a fourth section extending from an edge of the first section opposite the planar third section by bending the first piece of sheet material,
F) forming a fifth section extending from an edge of the fourth section opposite the first section by bending the first piece of sheet material, such that the first section, the fourth section and the fifth section form a right-angled U-shape,
G) attaching a reinforcement element at an interior side of the first section,
H) forming a sixth section extending from an edge of the second section opposite the third section by bending the first piece of sheet material, and
I) attaching a skirt element to the sixth section.

16. The flashing member according to claim 1, where the planar third section extends at angles of at least 120 degrees with respect to the first section and the second section.

17. The flashing member according to claim 6, where the flashing member is configured for use as a bottom flashing member mounted at the bottom frame member of the roof window mounted in an inclined roof.

18. The flashing member according to claim 1, where the sheet material is sheet metal comprising at least 50% recycled aluminium.

19. The flashing member according to claim 1, where a total height of the elongate main element along the height axis is at least 25 mm and less than 50 mm.

20. The flashing member according to claim 1, where a total height of the elongate main element along the height axis is at least 25 mm and less than 40 mm.
